(19) United States
(12) Patent Application Publication
(10) Pub. No.: US 2006/0107113 A1
(43) Pub. Date: May 18, 2006

(54) System and method for facilitating bi-directional test file transfer

(76) Inventor: Zhu Xing, Singapore (SG)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/977,689

(22) Filed: Oct. 29, 2004

(51) Int. Cl. G06F 11/00

(52) U.S. Cl. 714/15

(57) ABSTRACT

In one embodiment systems and methods are utilized that eliminate synchronization between cycles of a repetitive communication network quality test. This is accomplished by time-shifting each sample transmission to compensate for the time shift due to communication network delay and asymmetrical operation of network testers. In one embodiment, a dual-tone multi-frequency (DTMF) stamped sample signal is used to obtain an accounting of the time-shift that is necessary for each cycle. Once the necessary time-shift is determined, a time-shift alignment calibration (TSAC) and real-time auto-TSAC is used to implement continuous voice/video quality evaluations.

### BACKGROUND OF THE INVENTION

Often, it is necessary to send data files back and forth for communication network testing purposes. Communication networks must be evaluated on a continuous basis to insure high quality voice/video service. In order to continuously assess the voice/video quality between two locations, bi-direction continuous file transfer (i.e. file playing at one location and file recording at the other location) is carried out. In practice, the evaluation is executed by transmitting a data file (usually a speech/video speech sample) to the communication network under test by a first test device. This sample is received and recorded at a second test device. An uplink (from the first test device to the second test device) quality score is derived based upon any degradation of the sample between the original and the recorded sample. A downlink quality score (from the second test device back to the first test device) can be obtained using the same procedure in reverse. This procedure using round-trip samples is repeated periodically.

In order for bi-directional testing to work properly, synchronization is necessary between each file-play-record (FPR) instance in order to record the degraded file correctly and completely. If synchronization is not performed on each cycle, the accumulated time-shift during the testing cycles will cause the voice/video quality test (VQT) to be out of phase and the recorded files will be corrupted. However, synchronization between file-play-record (FPR) cycles consumes a lot of time, (sometimes on the order of 20-30 seconds) as compared to the length of the sample file itself which may only be 8-10 seconds. In addition to the time problem, the synchronization procedure hangs up from time to time, especially on mobile phone drive tests, and thus is unreliable.

### BRIEF SUMMARY OF THE INVENTION

In one embodiment systems and methods are utilized that eliminate synchronization between cycles of a repetitive communication network quality test. This is accomplished by time-shifting each sample transmission to compensate for the time shift due to communication network delay and asymmetrical operation of network testers. In one embodiment, a dual-tone multi-frequency (DTMF) stamped sample signal is used to obtain an accounting of the time-shift that is necessary for each cycle. Once the necessary time-shift is determined, a time-shift alignment calibration (TSAC) and real-time auto-TSAC is used to implement continuous voice/video quality evaluations.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of the invention having bi-directional file transfer;

FIG. 2 shows one example of prior art bi-directional file transfer;

FIG. 3 shows one embodiment of the invention illustrating a stamped file sample signal;

FIG. 4 shows one embodiment of the invention illustrating time sequences for continuous bi-directional file transfer;

FIGS. 5, 6, 7, and 8 show time lines for files as recorded;

FIG. 9 shows a compensated time line for a file;

FIGS. 10, 11A, 11B, and 12 show flow charts of time-shift calibration and compensation; and

FIG. 13 shows a blank diagram of one implementation embodiment.

### DETAILED DESCRIPTION OF THE INVENTION

As discussed above, when communication networks are to be evaluated on a continuous basis to insure a high quality of service, it is necessary to perform continuous bi-directional file transfers between locations. For such a system to work properly, synchronization is necessary between each file-play-record (FPR) instance in order to record the degraded file correctly and completely. In practice, the voice/video quality evaluation is executed by transmitting a file, such as a speech/video speech sample, from tester 11 over communication network 15 to second tester 12. The sample is received and recorded at the second tester. An uplink (13) quality score is derived based upon the degradation of the sample between the original and the recorded sample. A downlink (14) quality score can be obtained using the same procedure in reverse.

As shown in FIG. 2, the current measurement procedure for cycle 1 is to perform a synchronization operation by process 201 and 202 to be sure network evaluations, such as testers 11 and 12 are in phase. At the completion of this operation (which can be 20-30 seconds) process 203 begins where file A is sent uplink from tester 11 to tester 12 at process 204 and becomes known as file A1. Then, at processes 205, 206 another synchronization operation is performed. Then, to complete cycle 1, file A is sent back (process 208) to tester 11 from tester 12 (process 207), and the received file is known as file A2.

Uplink 2 (cycle 2) begins with processes 209 and 210 again performing a sync operation. Uplink 2 then continues with process 211 sending file A (this is the file that was received in cycle 1 from tester 12) uplink from tester 11 to process 212 for recording at tester 12 as file A3. Processes 214 and 213 perform another sync operation and then file A (the recorded A3 file) is sent via process 216 (tester 12) to process 215 (tester 11) while the file becomes file A4 thereby completing cycle 2. Note that had the synchronizations not been performed, the signal sample transmitted bi-directionally across the network would have become time-shifted and the comparison between a known signal and the received signal would yield an improper analysis.

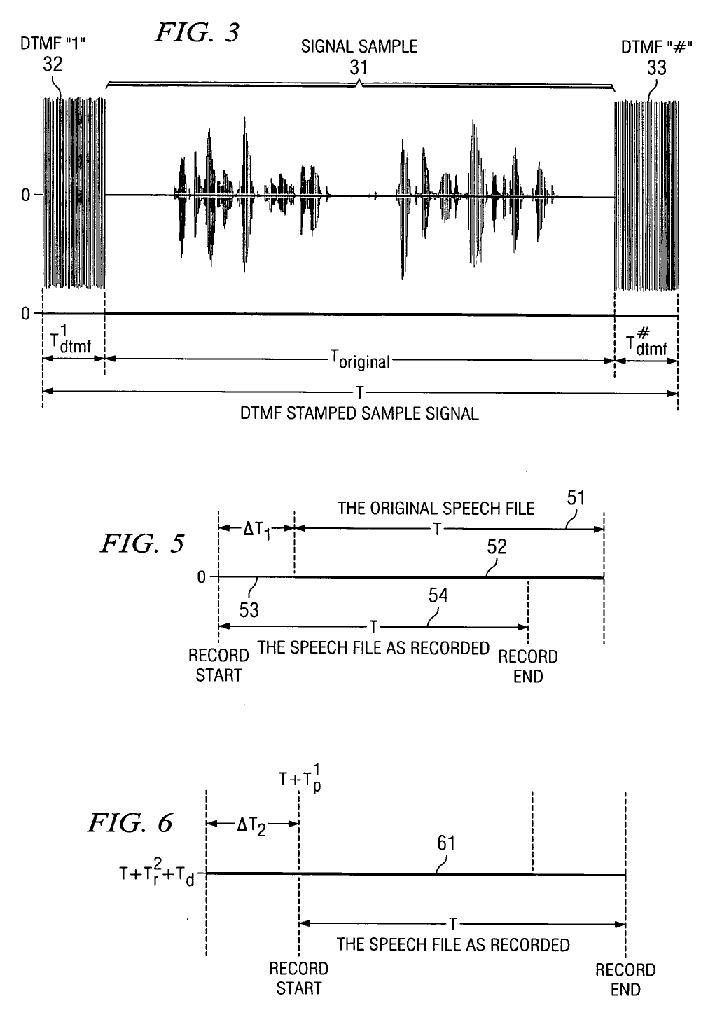

As a first step the elimination of the synchronization operation it is important to accurately determine the time-shift of a sample signal. One embodiment to accomplish this function is to use dual-tone multi-frequency (DTMF) signal markers (stamps) to define the sample signal. An example is shown in FIG. 3 where signal sample 31 is the original signal sample and can be as long (or short) as desired. Leading and trailing markers 32 and 33 are added to signal sample 31 to define the signal. In this example, these markers are DTMF signals (1, #), but could be any other known and easily generated and detected signal having a frequency compatible with the communication network. The total signal length is shown as 34 and is called the DTMF stamped sample signal having a time length of T.

Thus, as shown in FIG. 3, T_{original} is the length of the original sample signal used for current quality testing, and T_{dtmf}¹ and T_{dtmf}^{#} are the time lengths of the DTMF signals “1” and “#”, respectively added before and after original sample signal. The time T then is the sum of these three individual times. Note that any DTMF numeric can be used in substitution for “1” and “#”.

Because DTMF stamped sample signal 34 has stamps 32, 33 at the beginning and end of the original signal, the time-shift during FPR can be calculated accurately by detecting the time-shift of the DTMF stamp signals.

DTMF stamps were used because their generation and detection are now so very well known and there are many practical algorithms, such as the FFT method or the filter bank method which can be used to accurately detect the presence of the signal stamps.

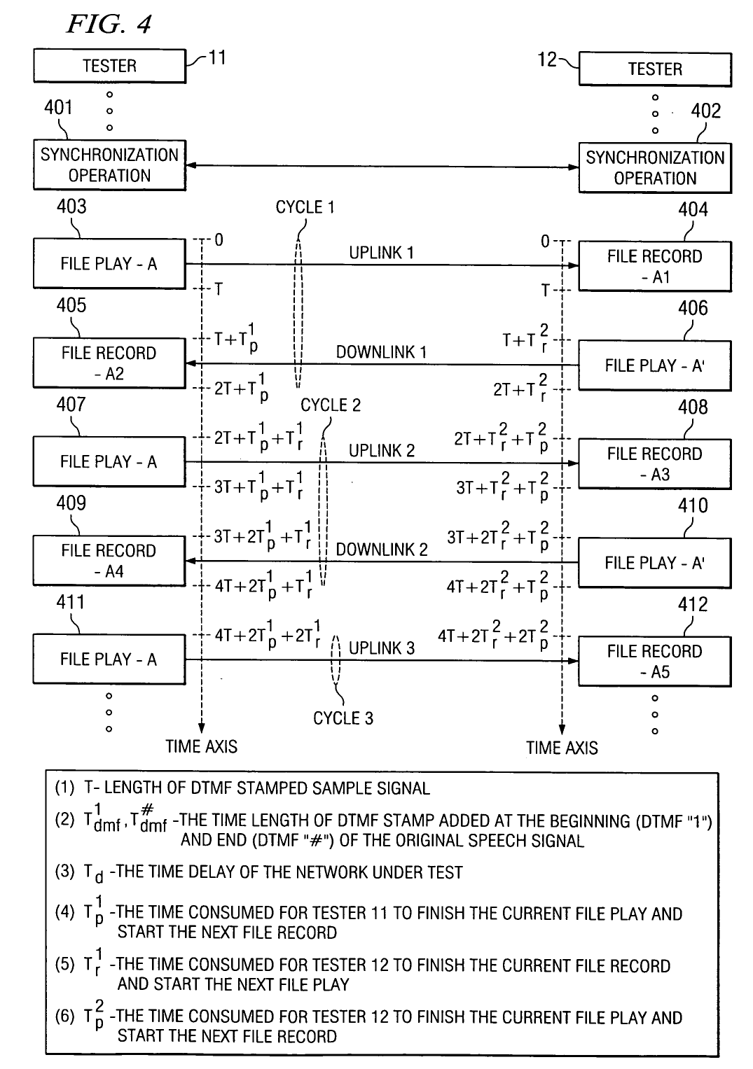

FIG. 4 shows one embodiment of the invention illustrating time sequences for continuous bidirectional file transfer. As can be seen, except for the first synchronization, processes 401, 402, all other synchronizations between file-play-record (FPR) cycles have been eliminated. In this manner, the time used for synchronization (previously 20-30 seconds per sync) is saved and hang-ups due to synchronization problems are avoided. Without synchronization, time-shifts will exist during FPR, these time-shifts must be removed. Adjusting for such time-shift will be called time-shift alignment methodology (TSAM). In order to implement TSAM, it is necessary to study the time sequence of a continuous file-play-record set of cycles as illustrated in FIG. 4 where:

| SYMBOL | MEANING |
|---|---|
| T | length of DTMF stamped sample signal |
| T_{dtmf}¹, T_{dtmf}^{#} | time length of each stamp signal added at the beginning |
| | (DTMF “1”) and end (DTMF “#”) of the original signal |
| T_{d} | time delay of the communication network under test |
| Tₚ¹ | time consumed for tester 11 to finish the current file play |
| | and start the next file record |
| Tᵣ¹ | time consumed for tester 11 to finish the current file |
| | record and start the next file play |
| Tₚ² | time consumed for tester 12 to finish the current file play |
| | and start the next file record |
| Tᵣ² | time consumed for tester 12 to finish the current file |
| | record and start the next file play |

It is reasonable to assume that Tₚ¹, Tᵣ¹, Tₚ², Tᵣ² are different because of the different tester devices. However, it is also reasonable to assume that they are constant or almost constant (i.e. with small variance) values between test cycles.

As shown in FIG. 4, for uplink 1 (processes 403, 404) of cycle 1, the tasklists of both tester 11 and tester 12 start at the same time point “0” after synchronization. For the second cycle, the start point for tester 11 (process 407) is 2 T+Tₚ¹+Tᵣ¹ and for tester 12 (process 408) the start point is 2 T+Tᵣ²+Tₚ². For the third cycle, the start point for tester 11 is 4 T+2 Tₚ¹+2 Tᵣ¹=2×(2 T+Tₚ¹+Tᵣ¹) and for tester 12 (process 412) the start point is 4 T+2 Tᵣ²+2 Tₚ²=2×(2 T+Tᵣ²+Tₚ²). Thus, for the ith circle, the start point for tester 11 is (i−1)×(2 T+Tₚ¹+Tᵣ¹) and for tester 12 the start point is (i−1)×(2 T+Tᵣ²+2 Tₚ²).

Because Tₚ¹≠Tₚ², Tᵣ¹≠Tᵣ² due to assumed asymmetrical operation of tasklists for testers 11 and 12, then 2 T+Tₚ¹+Tᵣ¹≠2 T+Tᵣ²+2 Tₚ². This means that the starting point of each cycle is different and that the time-shift at the ith cycle is Δ Tᵢ=(i−1)×((Tₚ¹+Tᵣ¹)−(Tᵣ²+Tₚ²)).

Now suppose 2 T+Tₚ¹+Tᵣ¹>2 T+Tᵣ²+Tₚ² and suppose inversely. Such assumptions will not affect final results.

From the above time-shift expression it is clear (as discussed above) that using CPFR without synchronization the time-shift Δ Tᵢ must be removed, otherwise the wrong file will be recorded due to bigger and bigger time-shifts.

In order to remove Δ Tᵢ, the time alignment problem for each cycle is considered. That is, let every test cycle be the same length, and thus, the next cycle will start at the same time point.

Because it is supposed 2 T+Tₚ¹+Tᵣ¹>2 T+Tᵣ²+Tₚ² and Δ T=(Tₚ¹+Tᵣ¹)−(Tᵣ²+Tₚ²), then if tester 12 is forced to execute its tasklist for a period of Δ T seconds more, then 2 T+Tₚ¹+Tᵣ¹=2 T+Tₚ²+Tₚ²+Δ T. This then implies that tester 11 and tester 12 complete their respective testing cycles at the same time. If this is so, then testers 11 and 12 will start their next testing cycle at the same time.

Now let us address the issue of forcing tester 12 to execute its tasklist for a period of Δ T seconds longer than tester 11. Referring again to FIG. 4, if Δ T seconds silence is added to the speech sample file A, i.e., the length of file A1¹ played by tester 12 (box 406) is T+Δ T seconds, then according to the time sequence analysis described in FIG. 4, the time length of the cycle of tester 12 is 2 T+Tᵣ²+Tₚ²+Δ T which is the same as the time consumed by tester 11. That is, every testing cycle will consume the same time, thus the time-shift is removed. Note that the added Δ T seconds silence will not affect tester 11 which performs as usual while tester 12 plays silence to balance the lost time. Thus, in order to remove time-shifting and maintain alignment, the fast side waits for the slower side so that the next testing cycle is started at the same time by both sides.

Next we will address how to calculate the time-shift Δ T that is to be added as silence to the speech sample file. The only information that is available to calculate Δ T is the recorded files A1, A2, A3, A4, etc.

For recorded file A1 (process 404) the play and record starts at the same time after the synchronization operation. However, considering the network delay T_{d}, the recorded file A1 is recorded as shown in FIG. 5 where the x-axis represents time sequence and thick solid line 51 is the time length of the original speech file, while thin solid line 52 is the time length of silence which occurred because the recording was started earlier than when the sample file arrived.

Note that in process 406 and process 410 although the played file's name is A¹ in both, the A¹ s may be different in different cycles because the added silence time may be different depending on the detected variant time shift. In other words, the new file A¹ generated with TSAC will replace the old file A¹, in order to correct for the time shift in this cycle.

From FIG. 5 it is clear that recorded file A1 actually has Δ T₁ length of silence at the beginning and loses Δ T₁ (53) length at the end of the sample signal. This is due to two reasons: namely (1) network delay, and (2) difference in record start times between testers 11 and 12. In practice, the network delay contributes the most to Δ T₁, and thus to simplify calculations, it is assumed that Δ T₁=T_{d}. It is tolerable if we let T_{dtmf}¹>Δ T₁ since some part of the stamp signal will be lost but all useful information is captured. It is worth noting that Δ T₁ (or T_{d}) can be calculated with the help of the stamp signal because of recorded file A1.

For recorded file A2 (process 405) or whether playing stars first at tester 12 (process 406) these cases are:
T+Tₚ¹>T+Tᵣ²+T_{d} (1)
T+Tₚ¹=T+Tᵣ²+T_{d} (2)
T+Tₚ¹<T+Tᵣ²+T_{d} (3)
In order to simplify the discussion, we will only discuss case (1). That is, suppose tester 11 consumes more time than does tester 12. For case (1),
Δ T₂=(T+Tₚ¹)−(T+Tᵣ²+T_{d})=Tₚ¹−Tᵣ²−T_{d} here we also assume T_{dtmf}¹>Δ T₂, i.e., the stamp signal is longer than the time-shift. This is shown in FIG. 6.

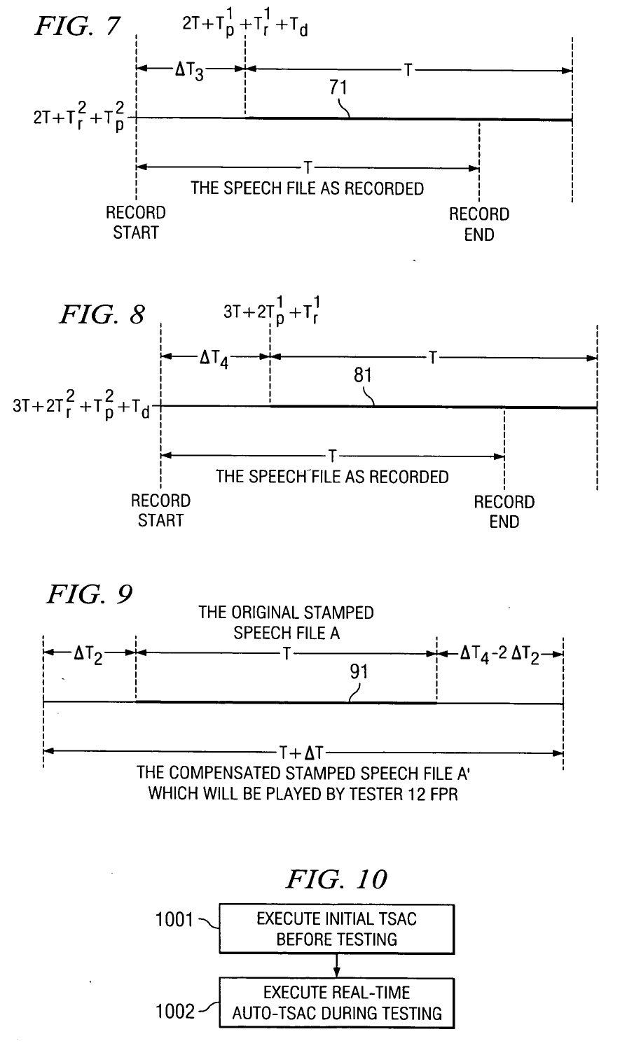

For recorded file A3 (process 408) which is uplink 2 there are three cases depending on whether recording starts first at tester 12 (process 408) or whether playing starting first at tester 11, process 407. These cases are:
2 T+Tₚ¹+Tᵣ+T_{d}>2 T+Tᵣ²+Tₚ² (1)
2 T+Tₚ¹+Tᵣ¹+T_{d}=2 T+Tᵣ²+Tₚ² (2)
2 T+Tₚ¹+Tᵣ¹+T_{d}<2 T+Tᵣ²+Tₚ² (3)
As above, in order to simplify the discussion, we will only discuss case (1). That is, assume tester 11 consumes more time than does tester 12. For case (1),
Δ T₃=(2 T+Tₚ¹+Tᵣ¹+T_{d})−(2 T+Tᵣ²+T_{d})=Tₚ¹+Tᵣ¹+T_{d}−Tᵣ²−Tₚ² here we also assume T_{dtmf}¹>Δ T₃, i.e., the stamp signal is longer than the time-shift. Again, Δ T₃ can be calculated because we have the recorded file A3. This is shown in FIG. 7.

For recorded file A4 (process 409) which is downlink 2 there are also three cases depending on whether recording starts first at tester 11 (process 409) or whether playing starts first at tester 12 (process 410). These cases are:
3 T+2 Tₚ¹+Tᵣ¹>3 T+2 Tᵣ²+Tₚ²+T_{d} (1)
3 T+2 Tₚ¹+Tᵣ¹=3 T+2 Tᵣ²+Tₚ²+T_{d} (2)
3 T+2 Tₚ¹+Tᵣ¹<3 T+2 Tᵣ²+Tₚ²+T_{d} (3)
As above, in order to simplify the discussion, we will only discuss case (1). That is, suppose tester 11 consumes more time than does tester 12. For case (1),
Δ T₄=(3 T+2 Tₚ¹+Tᵣ¹)−(3 T+2 Tᵣ²+Tₚ²+T_{d})=2 Tₚ¹+Tᵣ¹−T_{d}−2 Tᵣ²−Tₚ² here we also assume T_{dtmf}¹>Δ T₄, i.e., the stamp signal is longer than the time-shift. Again, Δ T₄ can be obtained because we have the recorded file A4. This is shown in FIG. 8.

From the above analysis of the recorded files, it is clear that the time-shift Δ T=Δ T₄−Δ T₂. Δ T can be calculated since Δ T=Δ T₃−T_{d}. Thus, from these two formulas, the compensation time Δ T can be derived from the recorded files. Δ T₄, Δ T₂, Δ T₃, T_{d} are calculated with the help of the stamp signal in the recorded speech files, as discussed above. After these values are calculated the value of Δ T can be calculated in order to achieve the time alignment after each cycle of testing.

From these formulas, it can be seen that the calculation of Δ T also depends on the time delay of the telecommunication network under test. If the network time delay changes, Δ T will also change. In order to solve this problem, real-time time-shift monitoring techniques can be used, as discussed below.

The compensation time Δ T can be divided into two parts to eliminate the time-shift of recorded file A2 as well as to achieve the time alignment. That is, in order to generate file A₁ from file A.

(a) Add Δ T₂ seconds length of silence to the beginning of the stamped original speech file A.

(b) Add Δ T₄−2 Δ T₂ seconds length of silence to the end of the original stamped speech file A.

Step (a) is used to let tester 12 (process 406) play the speech file a little later such that tester 11 will have enough time to start recording (process 405). Step (b) is used to compensate for the rest of the time-shift.

FIG. 9 shows the compensated stamped speech file A¹ which will be played by tester 12 in the downlink 1 test to eliminate the time-shift due to continuous FPR.

As previously discussed, and as shown in uplink 1 (FIG. 4) testing, file A1, as recorded by tester 12 (process 404), may lose the end part of file A due to delay. In order to solve this issue, Δ t seconds of silence is added to the end of file A is not lost. Δ T, as determined by experiment, represents the delay of the tester devices.

The implementation of the continuous FPR includes two parts as shown in FIG. 10. Process 1001 executes the initial time-shift alignment calibration (TSAC), and process 1002 executes the real-time auto-TSAC. The purpose of TSAC is to generate the compensated stamped speech file A¹ (FIG. 4) which will be played by tester 12 (process 406).

Process 1001 is the initial TSAC and is performed before the formal voice/video quality testing. The main purpose, as discussed above, is to obtain time-shift Δ T so as to be in a position to generate the compensated stamped speech file A¹.

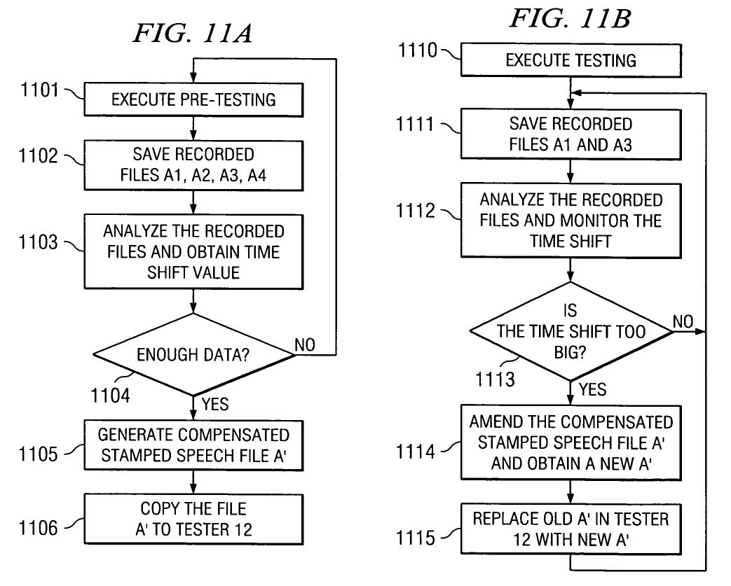

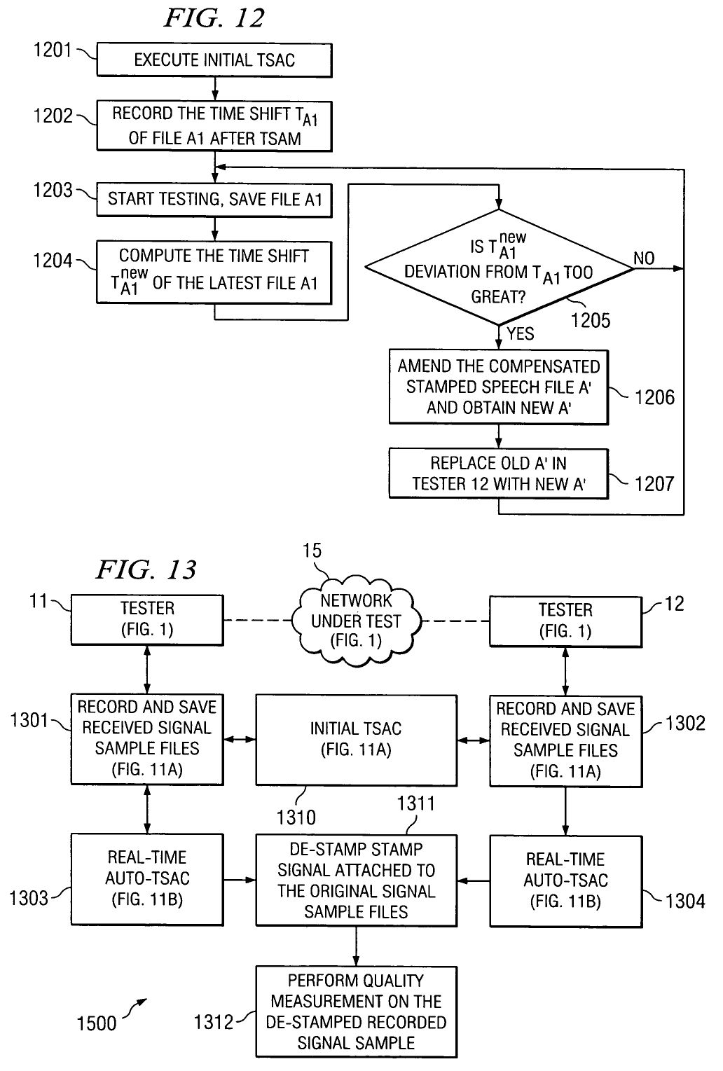

FIG. 11A is a flow chart illustrating how time compensation is achieved in the initial TSAC.

Process 1101 executes pretesting to obtain Δ T which represents the time-shift due to both tester devices and network delay. As discussed above, the tester's introduce most of the time-shift delay because the network delay should be less than 500 ms for a normal network. Process 1102 saves the recorded files A1, A2, A3, A4. Note that because the time-shift may be quite large, it might be advantageous to move the initial file A to a special file having only the stamp signal. This would be used only for the initial TSAC to determine Δ T accurately. After the initial TSAC, most of the time-shift in CFPR will be removed and the regular test signal can be used.

Process 1103 obtains the time-shift value, as discussed, and process 1104 determines if enough data has been recorded to determine proper compensation. If so, process 1105 generates the compensated file A¹ and process 1106 stores that file in tester 12 (process 404, FIG. 4).

Process 1002, FIG. 10 is performed during the formal testing. The main purpose is to eliminate the time-shift due to the network time delay and tester operation condition difference between initial TSAC and formal testing. Particularly, for the testing of mobile telecommunication network, the tester devices may be located on a van allowing for drive testing to be performed in different places, which may yield different network time delay.

FIG. 11B illustrates one example of real-time auto-TSAC operation. Process 1110 executes testing and process 1111 saves the recorded files A1 and A3. Process 1112 analyzes the recorded files A1 and A3, and determines whether the accumulated time-shift is bigger than a given threshold. If so, process 1114 amends the compensated stamped speech file A¹ and generates a new file A¹. Process 1115 replaces the old file A¹ with the new file A¹. The real-time auto-TSAC only uses file A1 and A3 so as to simplify the processing allowing for real-time testing.

FIG. 12 illustrates one embodiment of a TSAC algorithm in which process 1201 initiates testing and process 1202 records time-shift T_{A1} of file A1 so that file A1 can become a benchmark (process 1203). Note that T_{A1} may be equal to zero if the initial TSAC is perfect.

During testing, the computed time-shift T_{A1}^{new} of the latest file A1 (process 1204) is compared with the benchmark value T_{A1} in process 1205. If T_{A1}^{new} deviates from the benchmark value T_{A1}, then Δ T_{A1}=T_{A1}^{new}−T_{A1} represents the new time-shift arising after TSAC. In this case, the compensated stamped speech file A¹ is amended (process 1206) to remove the new time-shift. The amendment is executed by adding or reducing the silence part at the end of file A¹. Process 1207 replaces the old file A¹ with a new file A¹.

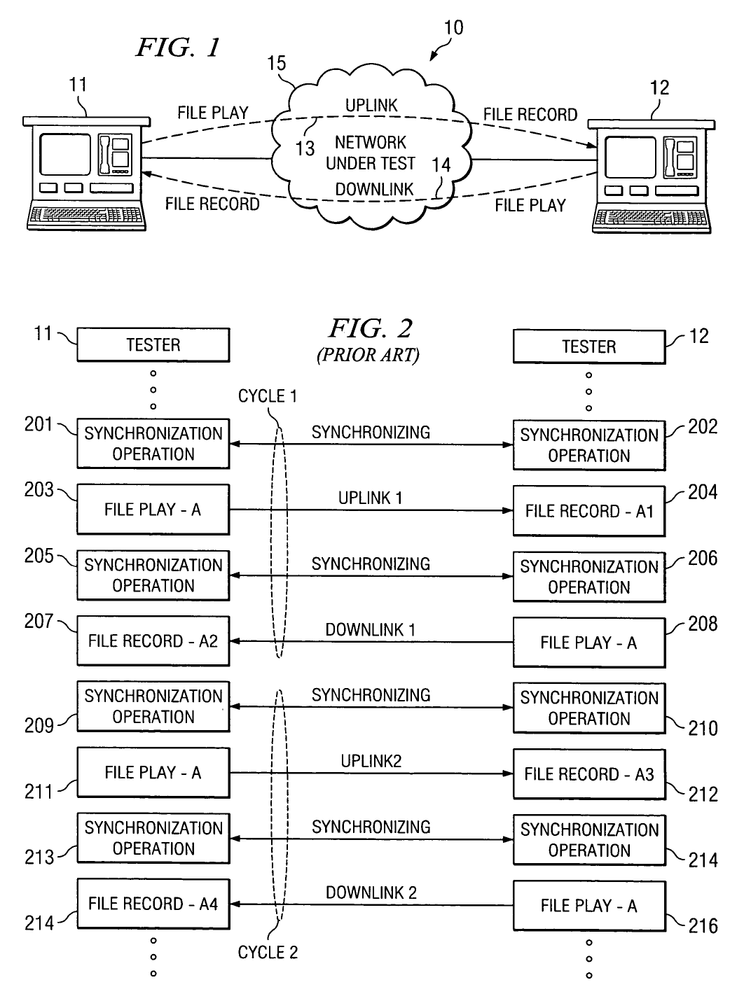

FIG. 13 shows one implementation in which system 1500 has testers 11 and 12, and network 15 as shown and discussed with respect to FIG. 1. Processes 1301, 1310, and 1302 have been shown and discussed with respect to FIG. 11A and processes 1303 and 1304 have been shown and discussed with respect to FIG. 11B. Process 1311 removes the DTMF stamp form the original kit signal and process 1311 performs quality testing by matching the compensated received signal against the original signal.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for facilitating bi-directional test file transfer comprising:
sending a test file from a first tester to a second tester over a communication network, said communication network and said testers each having delay;
recording said test file at said second tester; and
returning said recorded test file to said first tester such that said returned test file can be compared to said sent test file for quality purposes without synchronizing said testers with each other after said test file is recorded at said second tester.

2. The method of claim 1 wherein said returning is over said communication network.

3. The method of claim 1 wherein said test file is a speech file and wherein said returning comprises:
adding compensation time to said speech file to compensate for said delays.

4. The method of claim 3 wherein said compensation time is added at both the beginning and the end of said test file.

5. The method of claim 3 wherein compensation time is derived, at least in part, by adding known signals to the beginning and end of said test file so as to measure at least a portion of said delay.

6. The method of claim 5 wherein said known signals are DTMF signals representing two known DTMF numerics.

7. The method of claim 3 further comprising:
repeating said sending, recording and returning for a plurality of cycles, all without synchronizing said testers with each other.

8. The method of claim 7 further comprising:
from time to time adjusting said compensation time to account for changes in said delays.

9. The method of claim 1 further comprising:
synchronizing said testers with each other over said communication network prior to said initial sending of said test file.

10. A system for testing the quality of a communication connection, said system comprising:
a first tester for sending a sample voice quality signal to a second tester over a communication network, said communication network and said testers each having time shift due to communication network delay and asymmetrical operation of said first and second testers;
storage for recording received ones of said signal samples at said second tester; and
said second tester operable without being synchronized with said first tester after said received signal sample is recorded for returning over said communication network said recorded signal samples to said first tester such that said returned signal sample can be quality tested.

11. The system of claim 10 wherein said returned signal sample comprises:
time compensation added thereto to compensate for said delays.

12. The system of claim 11 wherein said compensation time is added at both the beginning and the end of said signal sample.

13. The system of claim 12 further comprising:
means for deriving said added compensation time, at least in part, by adding, on a one time basis, known signals to the beginning and end of an initial signal sample so as to measure at least a portion of said delays.

14. The system of claim 13 wherein said known signals are DTMF signals representing two known DTMF numerics.

15. The system of claim 10 further comprising:
means at said first and second testers operable for a plurality of cycles for repeating said sending, recording and returning, all without synchronizing said testers with each other throughout said plurality of cycles.

16. The system of claim 15 further comprising:
means operable from time to time for adjusting said compensation time to account for changes in said delays.

17. The system of claim 10 further comprising:
means for synchronizing said testers with each other over said communication network prior to said initial sending of said signal sample.

18. A method for continuous voice/video quality network evaluation, said method comprising:
synchronizing with each other network evaluators on each end of a communication network;
transmitting a voice/video quality sample over said network from a first network evaluator to a second network evaluator;
recording at a second network evaluator a received signal sample;
evaluating said signal sample for quality purposes;
adding compensation time to said recorded signal sample; the magnitude of said compensation time being dependant upon determined system delays, and without again performing said synchronization, retransmitting said recorded signal sample from said second network evaluator to said first network evaluator;
recording at said first network evaluator a received signal sample; and
evaluating at said first network evaluator said received signal sample for quality purposes.

19. The method of claim 18 further comprising:
repeating for a plurality of cycles said transmitting, said second network evaluator recording, said second network evaluating, said retransmitting and said first network evaluating, all without again performing said evaluator to evaluator synchronization.

20. The method of claim 19 further comprising:
from time to time adjusting the magnitude of said added compensation time depending upon a reevaluation of system delays.
